(19) United States
(12) Patent Application Publication
(10) Pub. No.: US 2023/0113583 A1
(43) Pub. Date: Apr. 13, 2023

(54) DUAL DENSITY MOLDED MEMBER, TOOLING AND METHOD THEREFOR

(71) Applicant: Intex Technologies, LLC, Hudsonville, MI (US)

(72) Inventor: Richard Claypool, Grand Haven, MI (US)

(21) Appl. No.: 17/866,433

(22) Filed: Jul. 15, 2022

Related U.S. Application Data
(60) Provisional application No. 63/222,382, filed on Jul. 15, 2021.

(51) Int. Cl. B29C 44/04; B29C 44/12

(52) U.S. Cl. CPC B29C 44/0446; B29C 44/1266; B29K 2075/00

(57) ABSTRACT

A dual density molded member, a dual density molded tooling, and a method of forming the dual density molded member, the dual density molded member including an outer shell comprising a self-skinning polyurethane foam, and a core comprising a urethane foam, the self-skinning polyurethane foam being higher in density than the urethane foam

### CROSS-REFERENCE TO RELATED APPLICATION

This application claims priority from U.S. Provisional Patent Application Ser. No. 63/222,382, filed on Jul. 15, 2021, entitled “DUAL DENSITY MOLDED MEMBER, TOOLING AND METHOD THEREFOR,” the entire disclosure of which is hereby incorporated by reference in its entirety.

### BACKGROUND OF THE DISCLOSURE

### 1. Field of the Disclosure

The disclosure relates in general to a molded member, and more particularly, to a dual density molded member, tooling, and method therefor.

### 2. Background Art

Molding typically consists of shaping a liquid or pliable raw material via rigid frame called a mold. The mold is a hollowed-out block that is filled with the liquid or pliable material, e.g., plastic, glass, metal, or ceramic raw material. The liquid sets or hardens inside the mold, adopting its shape. There are various types of molding including articulated molding, piece-molding, blow molding. A release agent is typically used to ease removal of a molded product from the mold. Molding can be used to make furniture, structural materials, household goods, cases, or any other product that can be manufactured via molding.

### BRIEF DESCRIPTION OF THE DRAWINGS

The disclosure will now be described with reference to the drawings wherein:

FIG. 1 illustrates an assembled isometric view of an example molding tooling with an example dual density molded member disposed within, in accordance with at least one configuration disclosed herein;

FIG. 2 illustrates an exploded isometric view of the molding tooling showing the dual density molded member, in accordance with at least one configuration disclosed herein;

FIG. 3 illustrates a second exploded isometric view of the molding tooling and the dual density molded member shown in FIG. 1, in accordance with at least one configuration disclosed herein;

FIG. 4 illustrates a detailed view of the dual density molded member shown in FIGS. 2 and 3, in accordance with at least one configuration disclosed herein;

FIG. 5 illustrates a first view the molding tooling being operated to manufacture the dual density molded member, shown in FIG. 1, in accordance with at least one configuration disclosed herein;

FIG. 6 illustrates a second view the molding tooling being operated to manufacture the dual density molded member, shown in FIG. 1, in accordance with at least one configuration disclosed herein; and

FIG. 7 illustrates a system including a stand-up lawn mower and the dual density molded member shown in FIG. 1, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

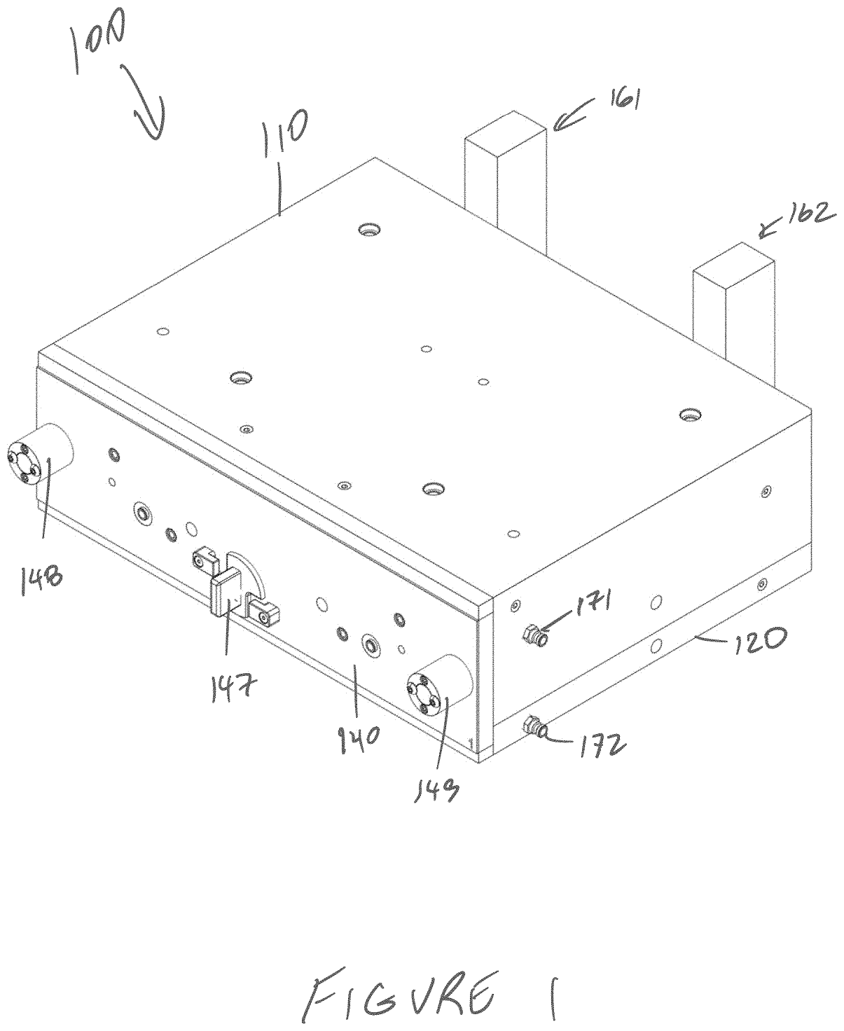

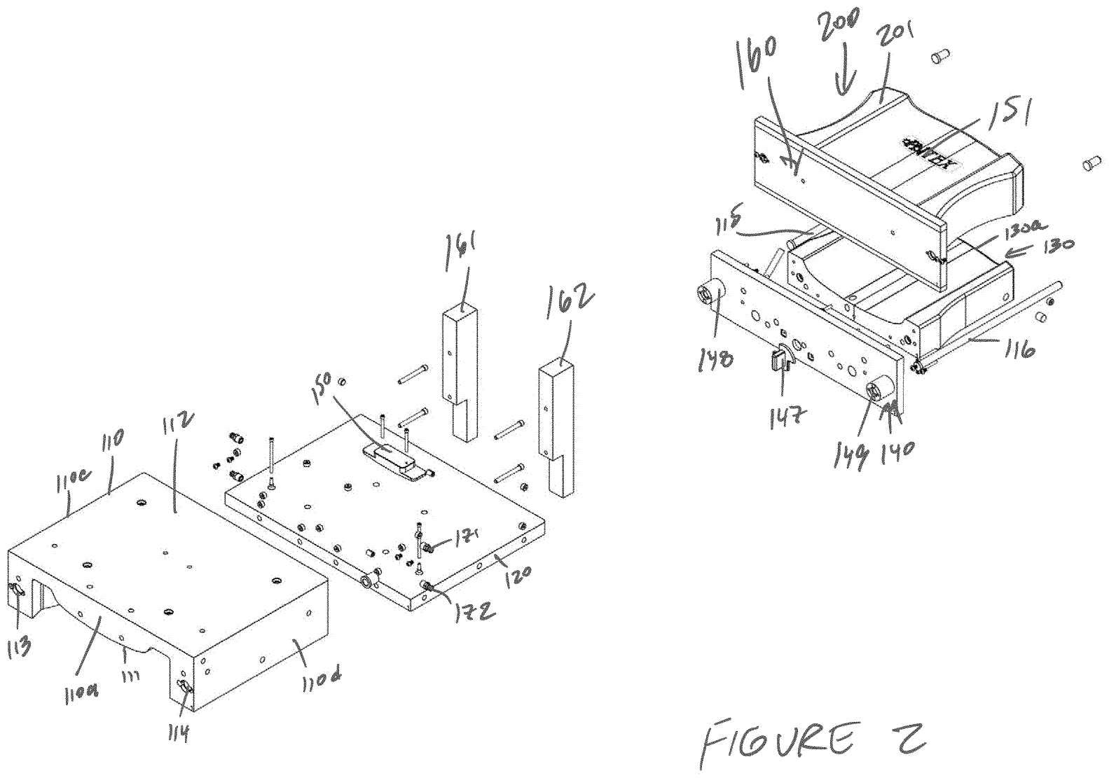

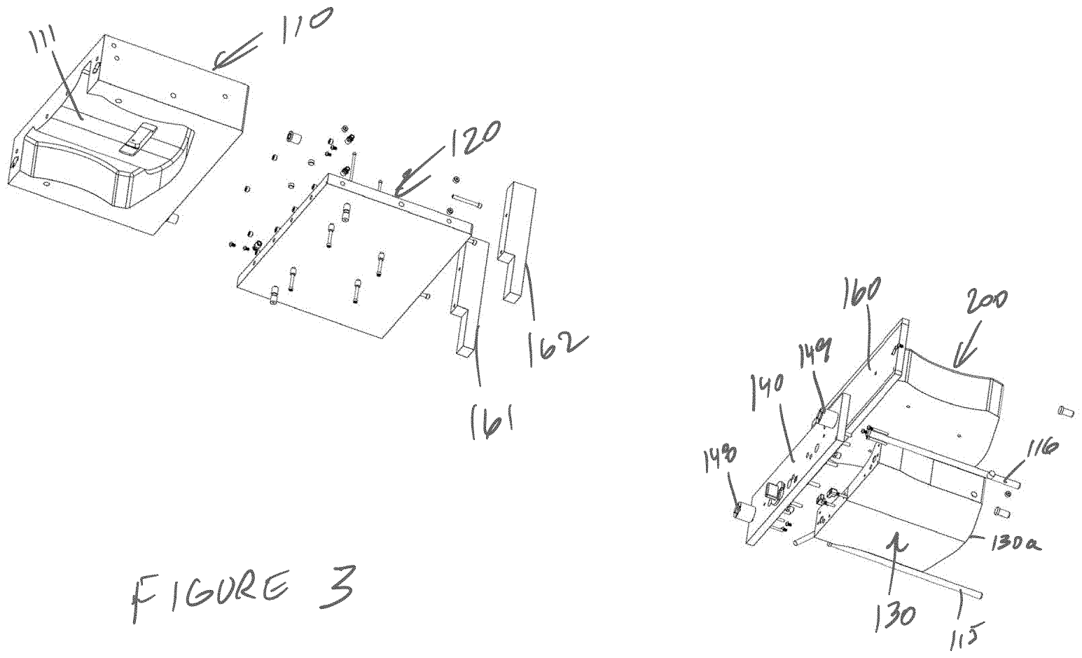

Referring now to the drawings and in particular to FIGS. 1-4, a dual density molded tooling apparatus, such as dual density molded tooling 100, used to manufacture a dual density molded member apparatus, such as dual density molded member 200, are illustrated. The dual density molded tooling 100 includes a base block 110. The base block 110 includes a contoured inside surface 111 and a non-contoured outside surface 112. The contoured inside surface 111 of the base block 110 is contoured to correspond to an outside surface 201 of the dual density molded member 200. Although the outside surface 112 of the molded tooling 100 can be otherwise configuration, in this example the outside surface 112 of the molded tooling 100 is rectangular in shape, with sides other than the contoured inside surface 111 being planar and being perpendicular to each other.

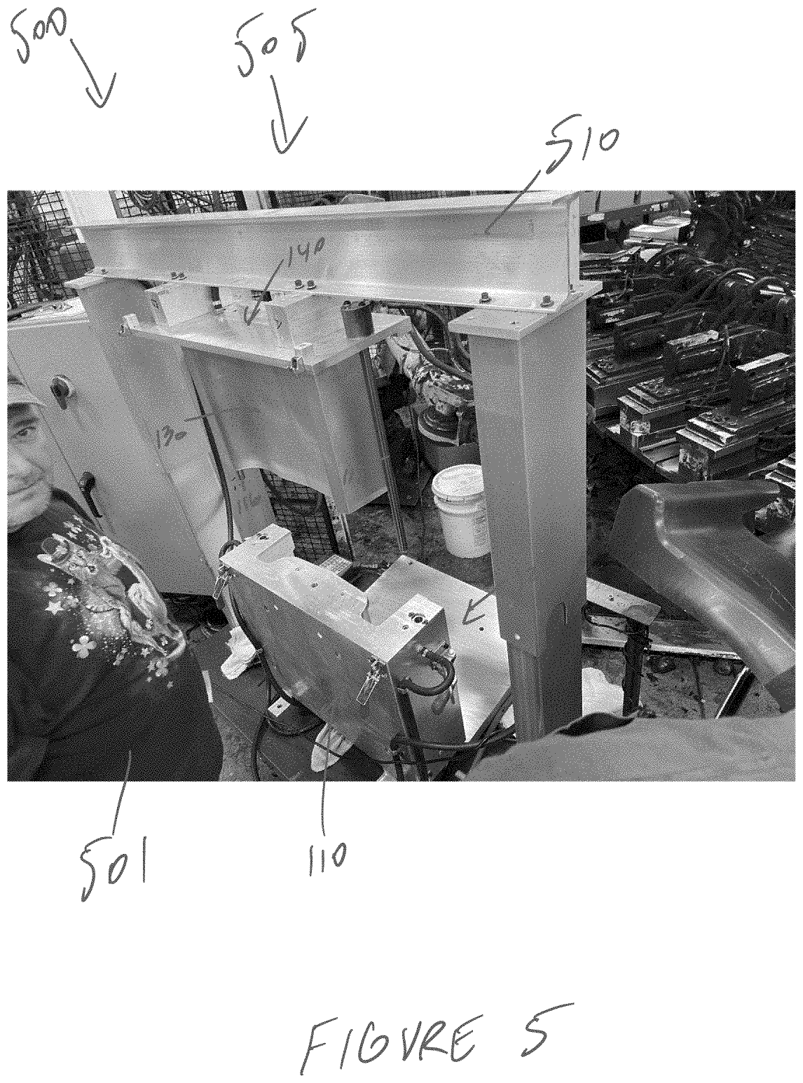

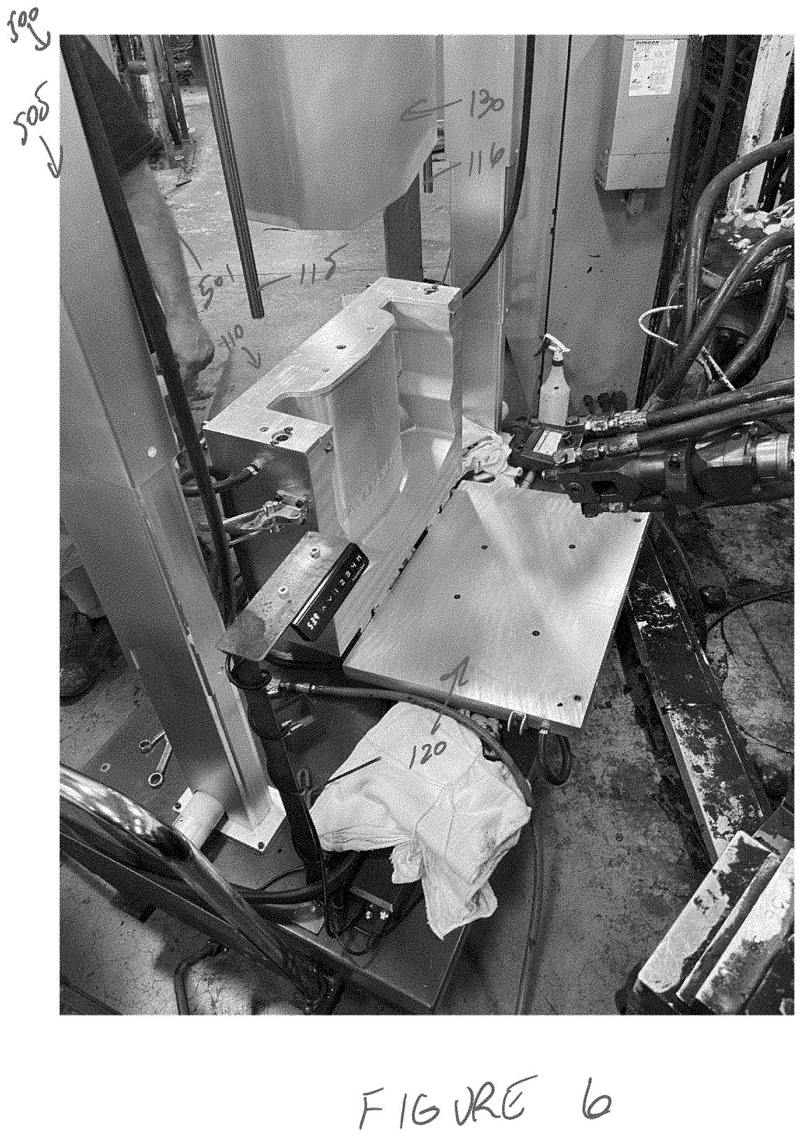

In at least one configuration, the base block 110 can further include first and second guide rod openings 113, 114 disposed on either side of the contoured inside surface 111, extending substantially parallel to first and second sides 110c, 110d of the base block 110. The first and second guide rod openings 113, 114 can extend from a first end 110a of the base block 110 to a second end 110b of the base block 110. The first and second guide rod openings 113, 114 accept first and second guide rods 115, 116, respectively. The first and second guide rods 115, 116 are coupled to a foam core mount cap 140, and can be vertically oriented during use as shown in FIGS. 5 and 6.

Disposed between the foam core mount cap 140 and a foam core substrate 130 used to form the dual density molded member 200 is a skin cap plate 160. The skin cap plate 160 includes first and second openings to allow the first and second guide rods 115, 116 to slide through these first and second openings. In this configuration, the first and second guide rods 115, 116, the foam core mount cap 140, and the foam core substrate 130 move as a single unit. The first and second guide rods 115, 116 enter the first and second guide rod openings 113, 114 to align the foam core substrate 130 as it enters a first inner cavity 117 formed when a base-side cap 120 is coupled to a side of the base block 110 facing the contoured inside surface 111. With the base-side cap 120 and the base block 110 so coupled, foam will not escape from the first inner cavity 117 during manufacture of the dual density molded member 200. In at least one configuration, first and second male plugs 171, 172 can be disposed through openings through the base block 110 and the base-side cap 120. The first and second male plugs 171, 172 allow molding fluid to enter the first inner cavity 117.

In at least one configuration, first and second guide rod extensions 148, 149 can be coupled to the foam core mount cap 140 on an outside surface thereof facing away from the foam core substrate 130. The first and second guide rod extensions 148, 149 correspond to the first and second guide rod openings 113, 114 and the first and second guide rods 115, 116. Substantially centrally on this same outside surface of the foam core mount cap 140 is shown a foam twist plug 147 that extends through an opening in foam core mount cap 140 to allow checking of an amount of foam fluid within the first inner cavity 117 during manufacture of the dual density molded member 200, the foam twist plug 147 being lockable against the forma core mount cap 140 via locking members, as shown.

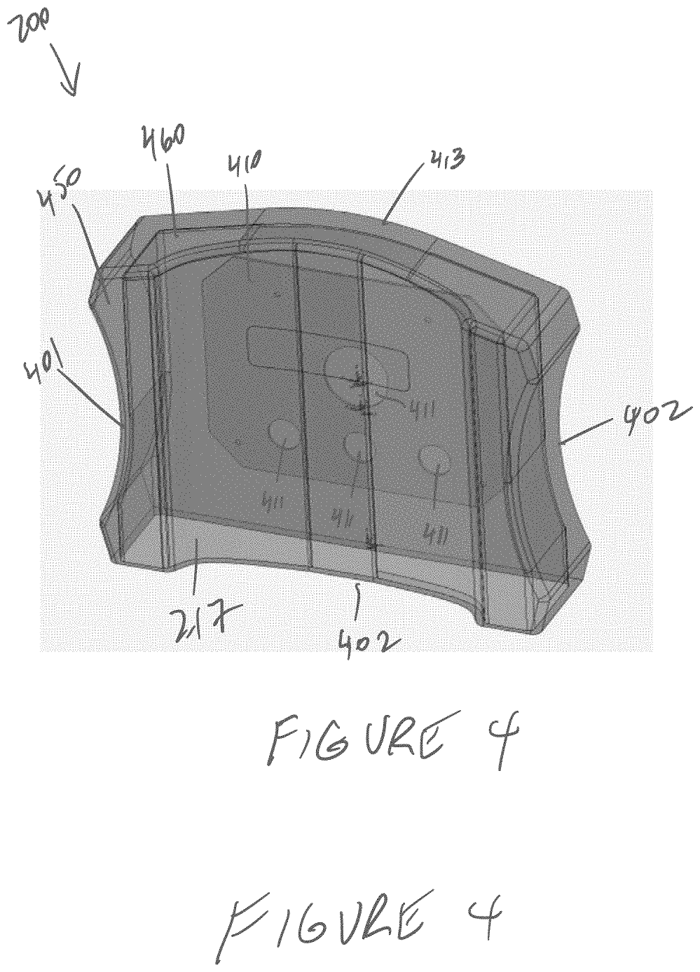

The foam core substrate 130 is shaped to follow a contour of the contoured inside surface 111 and the planar surface on the front of the base-side cap 120. When the foam core substrate 130 is disposed within the first inner cavity 117 formed when a base-side cap 120 is coupled to a side of the base block 110, as discussed above, a second inner cavity 217 (FIG. 4) is formed within the dual density molded member 200 during molding of the dual density molded member 200. The foam core substrate 130 is shorter in length than a length of the contoured inside surface 111 of the base block 110, such that when the foam core substrate 130 is disposed within first inner cavity 117 formed by the contoured inside surface 111 there is space for foam to cover a distal end 130a of the foam core substrate 130.

In the configuration shown, the base-side cap 120 is rectangular in shape, and planar on front and back sides thereof. This planar surface on a front surface of the base-side cap 120 produces a flat surface on a back of the dual density molded member 200. In at least one other configuration, the base-side cap 120 can be contoured, at least similar to the contoured inside surface 111, depending upon a desire shape for the dual density molded member 200. In at least one configuration, a text insert block 150 can be coupled (e.g., bolted) to the contoured inside surface 111 of the base block 110 such that when the dual density molded member 200 is being molded within the dual density molded tooling 100 text 151 can be imprinted onto a surface of the dual density molded member 200, as shown. In at least one configuration, first and second stabilizer feet 161, 162 can be coupled (e.g., bolted) to the base block 110 at the second end 110b thereof, that is on an opposite end of the back block 110 showing the first and second guide rod openings 113, 114.

In the example of the dual density molded member 200 disclosed herein shown in more detail in FIG. 4, the dual density molded member 200 can include tapered sides 401 on both sides of the dual density molded member 200, as shown. The dual density molded member 200 can include a flat bottom surface 402 and a curved top surface 403. In at least one configuration, the dual density molded member 200 can include a plate 410 (e.g., metallic plate) that provides rigidity and provides a mounting point for the dual density molded member 200. The plate 410 can be molded into the dual density molded member 200. The plate 410 can include various openings 411 disposed through the plate 410, the openings 411 can be used for mounting the plate 410. One skilled in the art would understand that the shape of the dual density molded member 200 is just an example, and that dual density molded member 200 can take on an unlimited number of shapes.

During use of the dual density molded tooling 100 to manufacture the dual density molded member 200 by an operator 501, a system 500 includes the foam core cap 140 coupled to a horizontal frame member 510 of a frame 505 that supports the foam core cap 140, the skin cap plate 160, and the foam core substrate 130, with the foam core substrate 130 pointing in a downward direction, as shown in FIGS. 5 and 6. The foam core cap 140, the skin cap plate 160, and the foam core substrate 130 move vertically up and down during manufacture of the dual density molded member 200. Then, the base-side cap 120 is coupled to a side of the base block 110, thereby forming the first inner cavity 117. An actuator (not shown) then moves the foam core cap 140, the skin cap plate 160, and the foam core substrate 130 downward until tops of the base block 110 and base-side cap 120 come to rest against a bottom of the skin cap plate 160. A higher density self-skinning polyurethane foam 450 (FIG. 4) is injected into the first inner cavity 117, the self-skinning polyurethane foam 450 flowing around the foam core substrate 130 thereby forming a shell.

Once the self-skinning polyurethane foam 450 is at least partially cured, the actuator lowers the coupled base-side cap 120 and base block 110, thereby exposing the dual density molded member 200. At this point, the dual density molded member 200 includes the second inner cavity 217. A lower density urethane foam 460 (FIG. 4) is then poured into the second inner cavity 217 as a core for the dual density molded member 200, that is lower in density than the self-skinning polyurethane 450 shell. Once the lower density urethane is cured, another mold cover (not shown) similar to the skin cap plate 160 is coupled to the coupled base-side cap 120 and base block 110. Additional higher density self-skinning polyurethane is then injected over the filled dual density molded member 200 to cover and seal the lower density urethane foam 460 now disposed within the second inner cavity 217. This other mold cover is then removed, and the base-side cap 120 is decoupled from the base block 110, allowing the filled dual density molded member 200 to be removed from the base block 110 by the operator 501.

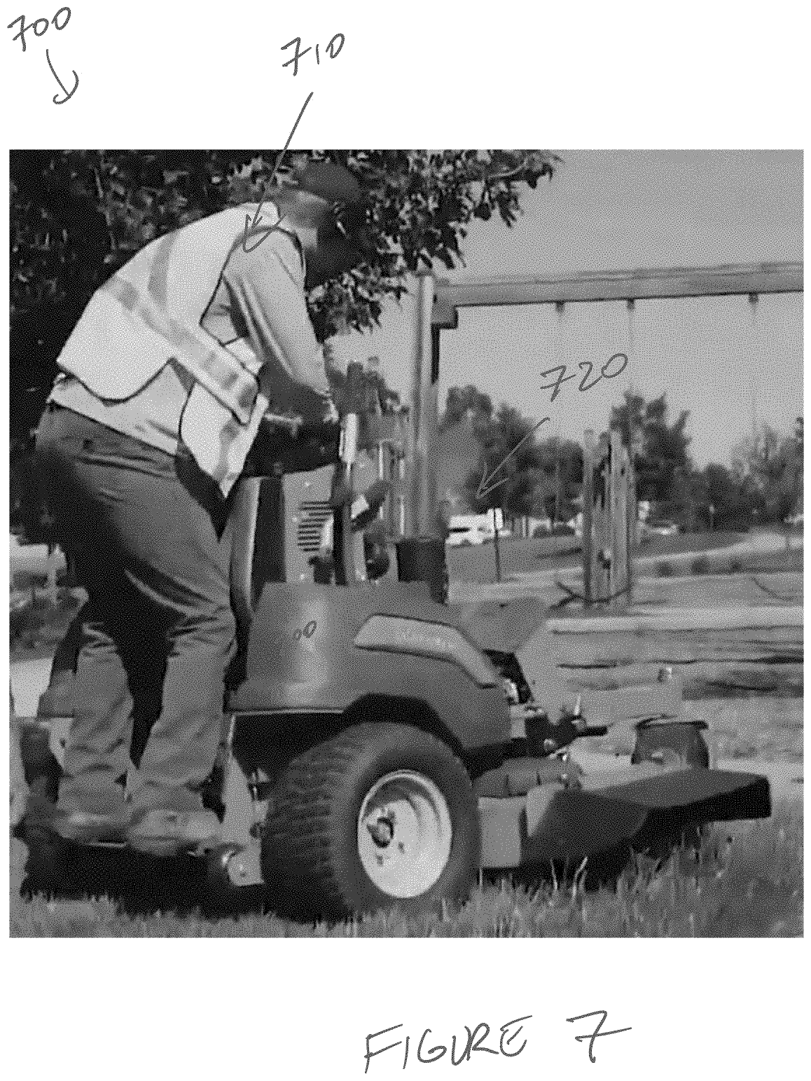

Such a configuration as described above for the dual density molded member 200 allows the dual density molded member 200 to be used as a cushion that can withstand rain, such as within a system 700 that includes an upstanding lawn mower 720 and the dual density molded member 200 (FIG. 7). As an outer portion of the dual density molded member 200 includes the higher density self-skinning polyurethane foam 450, this results in the dual density molded member 200 being water resistant. As an inner portion of the dual density molded member 200 includes the lower density lower density urethane foam 460, the dual density molded member 200 is also more compliant as compared to use of a single higher density cushion, the dual density molded member 200 providing comfort to an operator 710 of the upstanding lawn mower 720. Thus, the dual density molded member 200 therefore includes the higher density self-skinning polyurethane foam 450 as a shell over the lower density urethane foam 460, this combination providing both water resistance and comfort. Typical cushions for an upstanding lawn mower include a single type of foam covered with a vinyl material. The dual density molded member 200 is additionally more economical to produce that such a typical vinyl covered foam cushion.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A dual density molded member including an outer shell comprising a self-skinning polyurethane foam, and a core comprising a urethane foam, the self-skinning polyurethane foam being higher in density than the urethane foam.

2. A dual density molded tooling including a base block having a contoured inside surface, a base-side cap coupled to the base block to form a first inner cavity, and a foam core substrate to be disposed within the first inner cavity, the foam core substrate forming a second inner cavity within a dual density molded member, the dual density molded member including an outer shell comprising a self-skinning polyurethane foam, and a core comprising a urethane foam, the self-skinning polyurethane foam being higher in density than the urethane foam.

3. A method of forming a dual density molded member including an outer shell comprising a self-skinning polyurethane foam, and a core comprising a urethane foam, the self-skinning polyurethane foam being higher in density than the urethane foam, the method comprising coupling a base block having a contoured inside surface to a base-side cap coupled to form a first inner cavity, disposing a foam core substrate within the first inner cavity to form a second inner cavity within the dual density molded member.
